(19) United States
(12) Patent Application Publication
(10) Pub. No.: US 2007/0182224 A1
(43) Pub. Date: Aug. 9, 2007

(54) Bicycle seat

(76) Inventor: Mikael Jansch, Stockholm (SE)

Correspondence Address: JACOBSON HOLMAN PLLC, 400 SEVENTH STREET N.W., SUITE 600, WASHINGTON, DC, 20004, US

(21) Appl. No.: 10/591,838

(22) PCT Filed: Mar. 2, 2005
(86) PCT No.: PCT/SE05/00303

§ 371 Date: Sep. 5, 2006

(30) Foreign Application Priority Data
Mar. 3, 2004 (SE) 0400526-0

(51) Int. Cl. B62J 1/18

(52) U.S. Cl. 297/214

(57) ABSTRACT

Bicycle seat consisting of two from each other separated support portions for supporting one of the bicycle rider's (upper femur) seat bone, whereby each support portion is supported by a joint bar, which is arranged perpendicular to the central plane of the bicycle. In order to make the bicycle seat comfortable and specifically facilitate the movement of the seat bones when the rider pedals, it is suggested a combination including that each of the support portions is fixable on the bar and consists of at least three layers (6, 7, 8) firmly connected to each other by means of meeting surfaces, the undermost layer (6) being stiff and is fixable on the bar (3) and that the next layer (7) is a cushion, which is elastic in all directions. A third layer (8) is placed on the cushion and is stiff in all direction in its plane. The thickness of the cushion (7) is increasing in the direction to its forward edge and the elasticity is such that the surface pressure from the rider's seat bone when the thighs are moving up and down is met by the elasticity without the elasticity being completely consumed.

The present invention relates to a bicycle saddle consisting of two separated support portions, each one for supporting one of the bicycle rider's seat bones, (upper femur), the two support portions being mounted on a joint bar, which is arranged perpendicular to the central plane of the bicycle.

Bicycle seats of this kind are known from e.g. U.S. Pat. No. 4,387,925 and WO 00/09386.

The object of the present invention is to reach to such a design of the bicycle seat that the support portions of the seat will follow the movement of the seat bones when the rider's thigh bones move up and down, that is to say when the rider pedals his bicycle. The movement of the seat bone is three-dimensional, thus forward in the direction of the movement of the bicycle, sideways and downwards. The specific object of the present invention in relation to the known art is to design a bicycle seat which is very comfortable and includes as few movable parts as possible and is adjustable to the bodily constructional part of the rider.

An embodiment of the invention will be described in the following with reference to enclosed drawings.

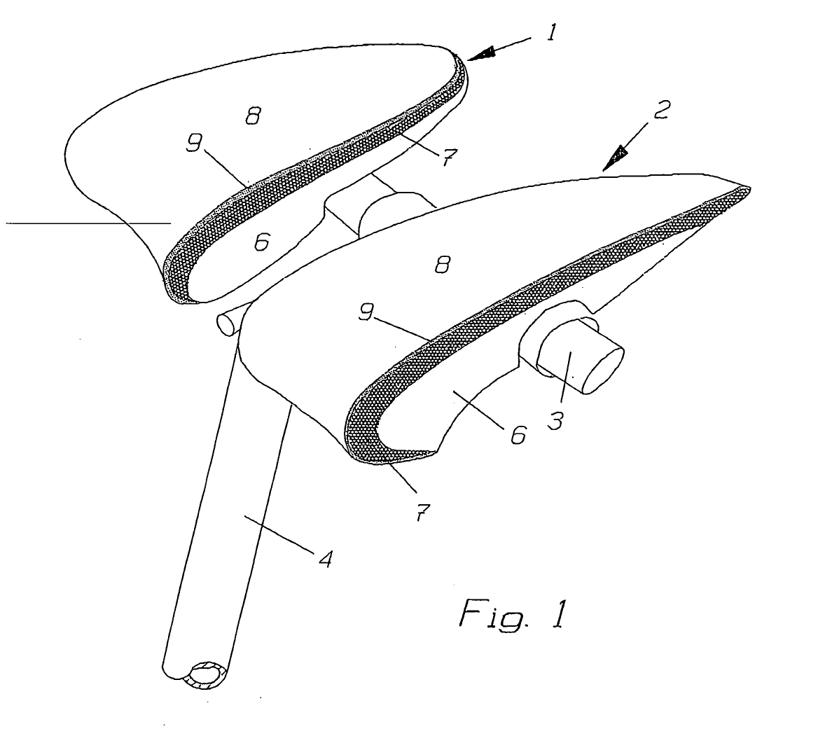

FIG. 1 is a perspective view of the bicycle seat seen from above from the front.

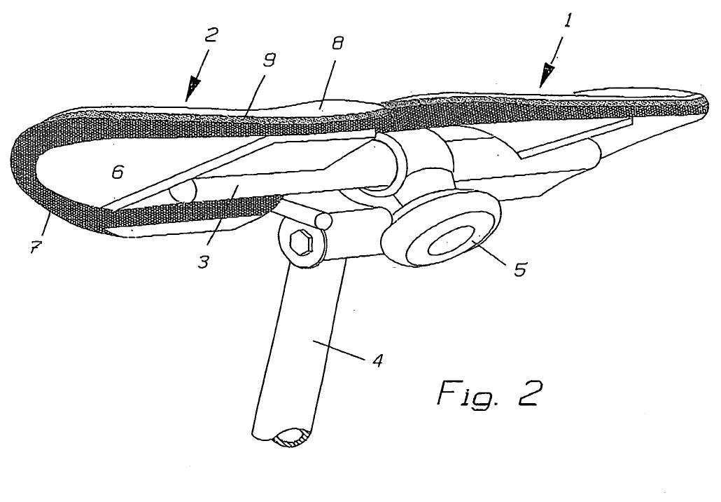

FIG. 2 is a perspective view of the bicycle seat seen from below from behind.

With reference to FIG. 1 it is seen that the bicycle seat consists of two support portions 1 and 2, which are arranged on a transversal mounting bar 3, which on its part is supported by a pool 4, which forms a part of the bicycle frame. The two support portions 1 and 2 can be displaced sideways on the bar 3 in relation to each other by being mounted each on a separate socket, which is slidable and rotatable on the bar and can be fastened by a handle 5. That means that the inclination of the support portions in relation to the horizontal plane can be adjusted and fixed by the handle 5. The two support portions 1 and 2 shall be fixed in relation to the bar 3 when the bicycle seat is used meaning that the two support portions shall not be able to tip or being displaced sideways. The bar 3 can be mounted to the pool 4 in different ways known per se and does therefore not form a part of the invention.

It can further be seen from FIG. 1 that the surface form of the support portions is such that they are wider at the forward edge than at the back edge. Further, it can be seen that the forward edge is round in order to give good comfort.

The advantage of the invention is now that each one of the support portions will meet and follow the movement of the seat bone without tipping or moving in some other way. Each of the support portions is therefore designed according to the following. The support portions consist mainly of three super imposed layers. The undermost one of the layers is a bottom plate 6, which can be fixed non turnable on the mounting bar 3, that is to say the bottom plate can not tip forward or backwards when fixed. The bottom plate 6 is suitably made from stiff sheet-metal. A second layer in the form of a cushion 7 is fastened to the bottom plate 6, the cushion being elastic in all directions. The elasticity of the cushion 7 shall be such that it is never totally compressed when being loaded by the rider but shall follow the movement of the rider's seat bone, which movement thus is as well known downwards and somewhat sideways, which taken together obliquely downwards and sideways. This movement is largest at the forward end of the support portion. The thickness of the cushion in this area is previously about 10 cm and the hardness is between 5-70 Shore A. As can be seen from FIG. 1 the thickness of the cushion is decreasing in the backward direction.

A third layer 8 is laid upon the cushion, which layer 8 is stiff in all directions in its plane. However, it should be observed that FIGS. 1 and 2 show an intermediate layer 9 in the form of foamed plastic but this layer is not necessary in order to achieve the desirable effect but is something which may improve the comfort. It should be noted that the three layers, the bottom plate 6, the cushion 7 and the upper layer 8 are united with each other via meeting surfaces by using some sort of adhesive means. The layers should not be able to slide in relation to each other.

Within the scope of the invention there are other embodiments than the above described and this concerns specifically the bottom plate and the upper layer 8. The bottom layer shall be stiff and thus suitably formed from metal. The uppermost layer 8 can be of woven fabric, leather or even thin metal plate. The elasticity of the cushion can be varied according to the rider's weight but should be so dimensioned that it can stand the weight of the person without being completely compressed when the rider pedals the bicycle.

1. Bicycle seat including two separated support portions each one for supporting one of the bicycle rider's upper seat bone, the two support portions being mounted on a joint bar, which is arranged perpendicular to the central plant of the bicycle, characterized in the combination that each one of the support portions is adjustably fixable mounted on said bar and consists of at least three layers which are secured to each other by means of the meeting surfaces, undermost one of the layers being nonflexible and mounted to the bar and the layer placed upon said nonflexible layer being a cushion, which is elastic in all directions and the uppermost layer being rigid in all directions in its plane, whereby the thickness of the cushion layer is increasing in the direction towards the front edge of the support portion and the elasticity is such that the surface pressure from the rider's seat bone caused by the up and down movement of rider's legs is taken up by the cushion layer without the cushion layer loses its elasticity.

2. The bicycle seat according to claim 1, characterized in that the two support portions can be fixed on the mounting bar with different mutual distances.

3. The bicycle seat according to claim 1, characterized in that the upper layer is made from leather.

4. The bicycle seat according to claim 1, characterized in that the upper layer is formed from sheet metal.

5. The bicycle seat according to claim 1, characterized in that the cushion forming the middle layer has a thickness of at least 10 mm and a hardness of 5-70 Shore A.

6. The bicycle seat according to claim 1, characterized in that the support portions are wider at the forward end than at the rear end and that the forward edge is round by that the forward end of the cushion is round.

7. The bicycle seat according to claim 1, characterized in that a foam plastic layer is arranged between the uppermost layer and the cushion whereby the upper layer consists of a woven fabric.
